(19) United States
(12) Patent Application Publication
(10) Pub. No.: US 2016/0174146 A1
(43) Pub. Date: Jun. 16, 2016

(54) METHOD AND DEVICE FOR CONNECTING APPLIANCE TO NETWORK

(71) Applicant: Xiaomi Inc., Beijing (CN)

(72) Inventors: Yang WANG, Beijing (CN); Qiang FU, Beijing (CN); Enxing HOU, Beijing (CN)

(73) Assignee: Xiaomi Inc.

(21) Appl. No.: 14/963,505

(22) Filed: Dec. 9, 2015

Related U.S. Application Data
(63) Continuation of application No. PCT/CN2015/080680, filed on Jun. 3, 2015.

(30) Foreign Application Priority Data
Dec. 15, 2014 (CN) 201410777958.1

(51) Int. Cl. H04W 48/18; H04W 28/02; H04W 12/08; H04H 20/53; H04W 68/00

(52) U.S. Cl. CPC H04W 48/18; H04H 20/53; H04W 68/005; H04W 12/08; H04W 28/0247; H04W 88/02

(57) ABSTRACT

A method for connecting an unconnected smart appliance to a wireless network includes receiving appliance information broadcast by the unconnected smart appliance, displaying a notification for connecting the unconnected smart appliance to the wireless network, receiving a connecting instruction triggered by a user according to the notification, and connecting the unconnected smart appliance to the wireless network according to the connecting instruction. The appliance information at least contains an appliance identification of the unconnected smart appliance.

### CROSS-REFERENCE TO RELATED APPLICATIONS

This application is a Continuation Application of International Application No. PCT/CN2015/080680, filed Jun. 3, 2015, which is based upon and claims priority to Chinese Patent Application No. CN201410777958.1, filed Dec. 15, 2014, the entire contents of both of which are incorporated herein by reference.

### TECHNICAL FIELD

The present disclosure generally relates to computer technology and, more particularly, to a method and device for connecting an appliance to a network.

### BACKGROUND

Many smart appliances have a network function, and can be connected to a wireless network. In order to connect a smart appliance to a wireless network, network information, which may contain a network name and a password, is sent to the smart appliance by a terminal. After acquiring the network information, the smart appliance can search for the wireless network according to the network name, and then can be connected to the wireless network according to the password.

### SUMMARY

In accordance with the present disclosure, there is provided a method for connecting an unconnected smart appliance to a wireless network. The method includes receiving appliance information broadcast by the unconnected smart appliance, displaying a notification for connecting the unconnected smart appliance to the wireless network, receiving a connecting instruction triggered by a user according to the notification, and connecting the unconnected smart appliance to the wireless network according to the connecting instruction. The appliance information at least contains an appliance identification of the unconnected smart appliance.

Also in accordance with the present disclosure, there is provided a terminal for connecting an unconnected smart appliance to a wireless network. The terminal includes a processor and a non-transitory computer-readable storage medium storing instructions. The instructions, when executed by the processor, cause the processor to receive appliance information broadcast by the unconnected smart appliance, display a notification for connecting the unconnected smart appliance to the wireless network, receive a connecting instruction triggered by a user according to the notification, and connect the unconnected smart appliance to the wireless network according to the connecting instruction. The appliance information at least contains an appliance identification of the unconnected smart appliance.

Also in accordance with the present disclosure, there is provided a non-transitory computer-readable storage medium storing instructions. The instructions, when executed by a processor of a terminal, cause the terminal to receive appliance information broadcast by an unconnected smart appliance, display a notification for connecting the unconnected smart appliance to a wireless network, receive a connecting instruction triggered by a user according to the notification, and connect the unconnected smart appliance to the wireless network according to the connecting instruction. The appliance information at least contains an appliance identification of the unconnected smart appliance.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for connecting an appliance to a network according to an exemplary embodiment.

FIG. 2A is a flow chart of a method for connecting an appliance to a network according to another exemplary embodiment.

FIG. 2B shows an interface of a list of smart appliances according to an exemplary embodiment.

FIG. 2C is shows an interface of a list of smart appliances according to another exemplary embodiment.

FIG. 2D shows an interface containing a notification icon according to an exemplary embodiment.

FIG. 2E shows an interface containing a notification icon according to another exemplary embodiment.

FIG. 2F shows an interface containing smart-appliance information according to an exemplary embodiment.

FIG. 2G shows an interface containing smart-appliance information according to another exemplary embodiment.

FIG. 2H is a schematic diagram showing an interface of a smart-appliance notification according to an exemplary embodiment.

FIG. 2I is a schematic diagram showing a network-selecting interface according to an exemplary embodiment.

FIG. 3 is a block diagram of a device for connecting an appliance to a network according to an exemplary embodiment.

FIG. 4 is a block diagram of a device for connecting an appliance to a network according to another exemplary embodiment.

FIG. 5 is a block diagram of a device configured to connect an appliance to a network according to another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses and methods consistent with aspects related to the invention as recited in the appended claims. In addition, apparatuses and methods according to the present disclosure can be implemented in, for example, a terminal.

FIG. 1 is a flow chart of a method for connecting an appliance to a network according to an exemplary embodiment. As shown in FIG. 1, at 101, appliance information broadcast by a smart appliance is received. The appliance information at least contains an appliance identification of the smart appliance. At 102, a notification for connecting the smart appliance to a wireless network is displayed. At 103, if a connecting instruction triggered by a user according to the notification is received, the smart appliance is connected to the wireless network according to the connecting instruction.

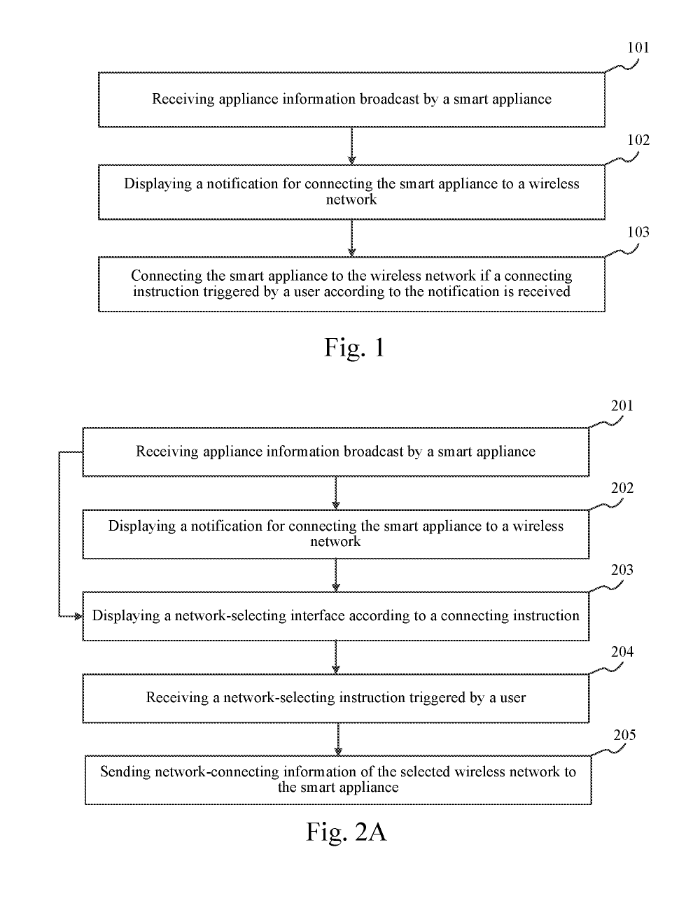

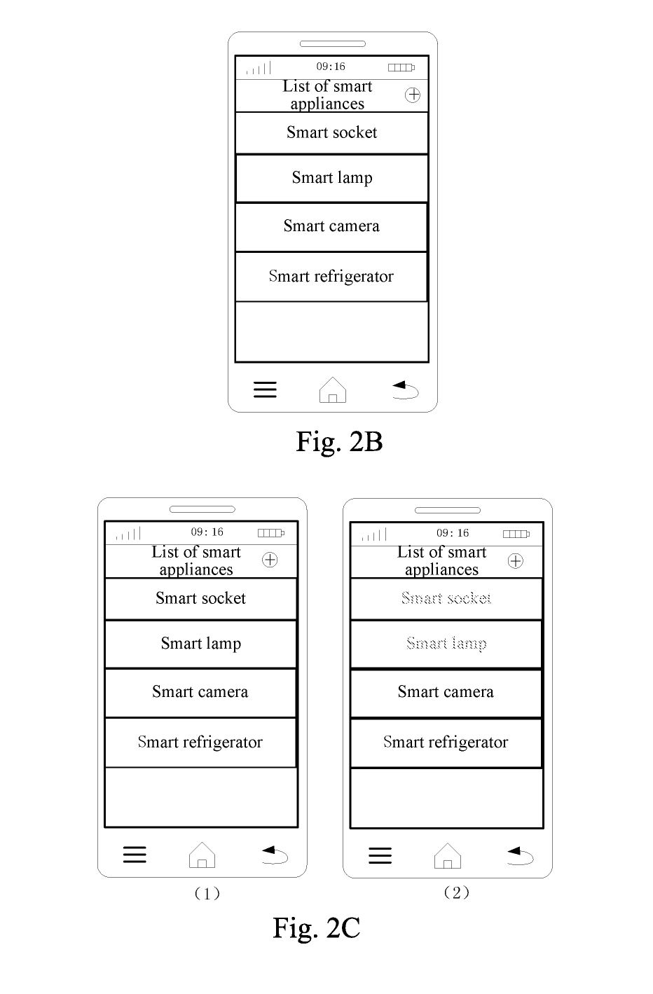

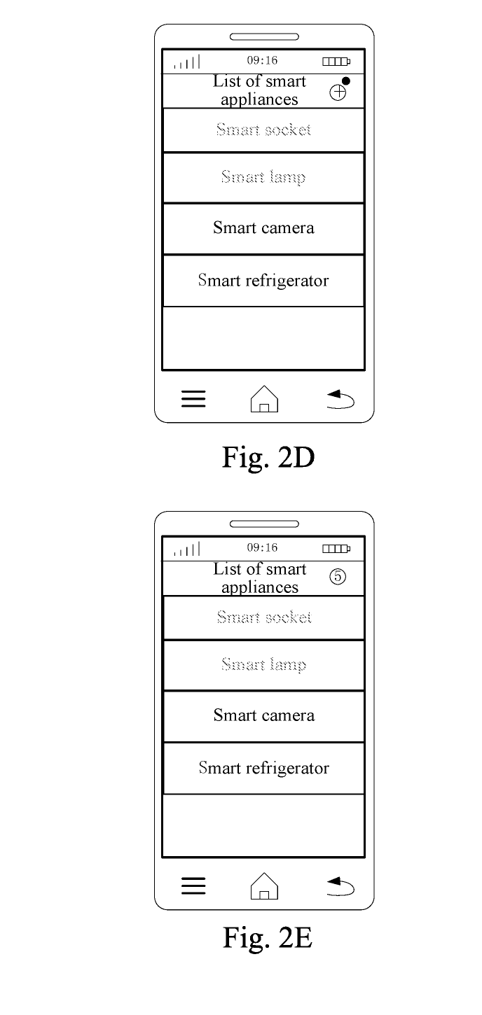

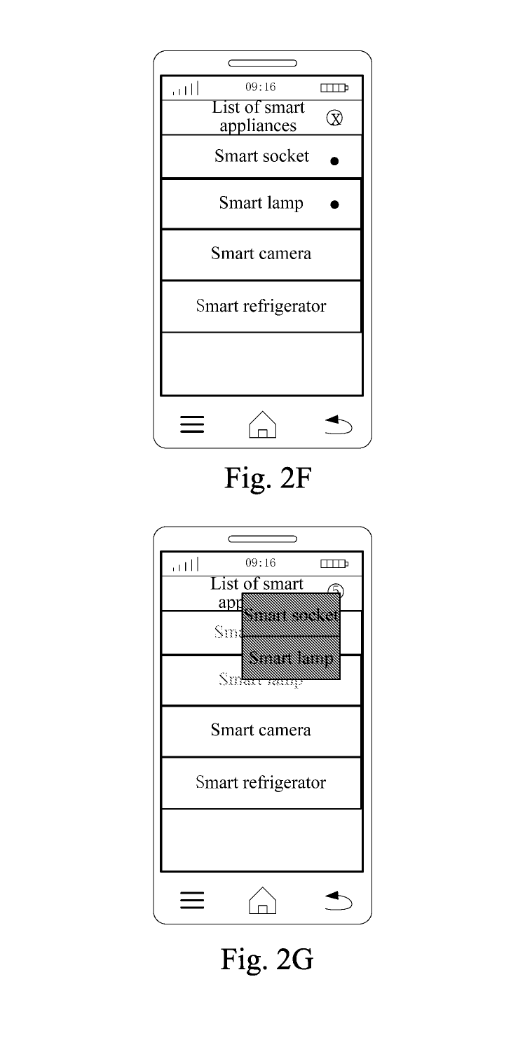

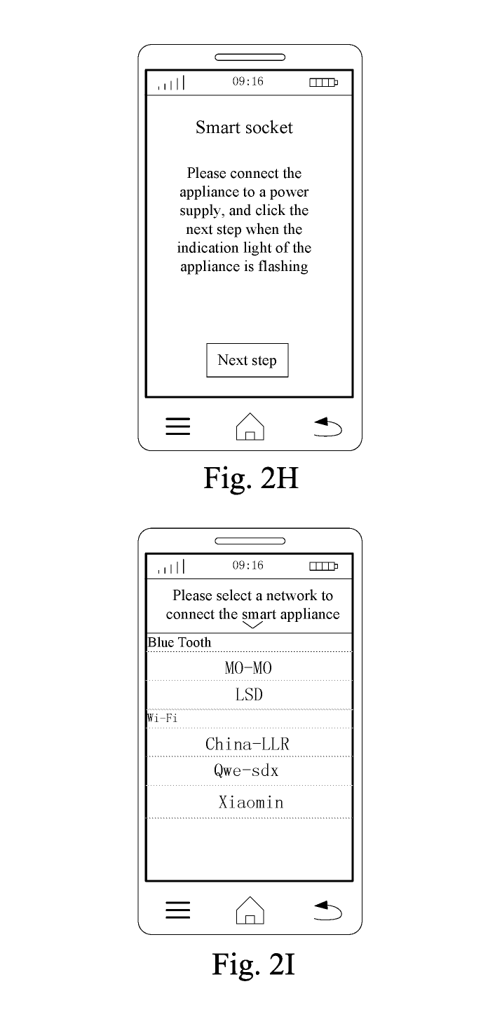

FIG. 2A is a flow chart of a method for connecting an appliance to a network according to another exemplary embodiment. As shown in FIG. 2A, at 201, appliance information broadcast by a smart appliance is received. The appliance information at least contains an appliance identification of the smart appliance.

As used here, a smart appliance refers to an appliance having a broadcast function and a network-connecting function, such as a smart socket, a smart camera, a smart air purifier, a smart remoter, a smart door bell, or the like.

In some embodiments, the smart appliance may acquire its own appliance information, and broadcast the appliance information periodically. A terminal near the smart appliance can determine the presence of the smart appliance after receiving the appliance information. Specifically, the appliance information at least contains an appliance identification that identifies the smart appliance. In some embodiments, the appliance information may also contain other information such as, for example, introduction to a function, an icon, and state information, of the smart appliance.

At 202, a notification for connecting the smart appliance to a wireless network is displayed on the terminal, which may be connected to the wireless network, so that the user can determine whether to connect the smart appliance to the wireless network. The wireless network may be, for example, a Blue Tooth network or a WiFi (Wireless Fidelity) network.

According to the present disclosure, the notification can be displayed differently in different scenarios. For example, a current interface of the terminal is a display interface showing a list of smart appliances. The list contains at least one of appliance information of smart appliances that are connected to the wireless network, hereinafter also referred to as “connected smart appliances,” and appliance information of smart appliances that are not connected to the wireless network, hereinafter also referred to as “unconnected smart appliances.” In this scenario, the appliance information broadcast by the smart appliance to be connected can be added to the list. For example, FIG. 2B is a schematic diagram showing an example of the list of smart appliances. In FIG. 2B, a smart camera and a smart refrigerator are connected to the wireless network while a smart socket and a smart lamp are not connected to the wireless network.

In some embodiments, the terminal displays the smart appliances in an order of receiving time of their respective appliance information. In some embodiments, the terminal further classifies the smart appliances according to whether they are connected to the wireless network, and highlights the unconnected smart appliances.

In some embodiments, when adding and displaying the received appliance information to the list of smart appliances, the terminal identifies one or more unconnected smart appliances in the list and displays appliance information of the identified unconnected smart appliances in a flashing manner.

In some embodiments, the terminal identifies all the unconnected smart appliances in the list, and displays appliance information of these smart appliances in a flashing manner. That is, the appliance information of the unconnected smart appliances switches between a bright state and a dim state at a flashing frequency. When in the bright state, the appliance information of the unconnected smart appliances is approximately as bright as the appliance information of the connected smart appliances. When in the dim state, the appliance information of the unconnected smart appliances is darker than the appliance information of the connected smart appliances. The flashing frequency of the appliance information of a smart appliance can be the same as or different from that of a notification light of the smart appliance.

FIG. 2C is a schematic diagram showing an example of the list of smart appliances. In pane (1) of FIG. 2C, the appliance information of the unconnected smart appliances, i.e., the smart socket and the smart lamp, is displayed in the bright state, like the appliance information of the connected smart appliances, i.e., the smart camera and the smart refrigerator. On the other hand, in pane (2) of FIG. 2C, the appliance information of the unconnected smart appliances switches to the dim state and is thus darker than the appliance information of the connected smart appliances.

In some embodiments, the terminal may only display the appliance information of a smart appliance that is currently acquired in a flashing manner, to distinguish the unconnected smart appliance currently acquired from those previously acquired.

In some embodiments, instead of displaying the received appliance information in a flashing manner, the terminal may display a notification icon in a predetermined item on a current interface, to notify the user of the existence of an unconnected smart appliance. The current interface may be a display interface of the list of smart appliances, or another type of display interface. The predetermined item is configured to provide a link from the current interface to a display interface of the unconnected smart appliance.

In some embodiments, displaying the notification icon in the predetermined item on the current interface of the terminal includes displaying a colored dot, e.g., red, at a predetermined position of the predetermined item. In some embodiments, the terminal acquires the number of the smart appliances and displays the number at the predetermined position of the predetermined item. The predetermined position can be a position near the predetermined item, such as at upper right or lower right to the predetermined item.

FIG. 2D shows an example of the notification icon, which includes, for example, a colored dot, e.g., red, displayed in the predetermined item on the current interface of the terminal. In this example, the terminal displays the colored dot at a location to the upper right of a button, which is illustrated as a circle having a cross therein in FIG. 2D, of the predetermined item on the display interface of the list of smart appliances. After seeing the colored dot, the user is aware of the presence of the unconnected smart appliance.

In some embodiments, instead of the colored dot, the terminal may display a pattern with other shapes or other colors at the predetermined position of the predetermined item, to notify the user.

FIG. 2E shows another example of the notification icon, which includes, for example, the number of unconnected smart appliances displayed in the predetermined item of the current interface of the terminal. In the example shown in FIG. 2E, the number of unconnected smart appliances is 5, and thus the number “5” is displayed on the button of the predetermined item.

After displaying the notification icon in the predetermined item on the current interface, the terminal may also receive a checking instruction triggered by the user according to the predetermined item, and display the appliance information according to the checking instruction.

According to the present disclosure, to display the appliance information of the unconnected smart appliances, the terminal can switch from the current interface to the display interface of the list of smart appliances and display the appliance information of the unconnected smart appliances. Alternatively, the terminal can display the list of unconnected smart appliances in a pop-up window in the current interface, and display the appliance information of the unconnected smart appliances in the list of smart appliances.

According to the present disclosure, the list of unconnected smart appliances may contain appliance information of all the unconnected smart appliances or may contain appliance information of the unconnected smart appliances that is currently acquired.

In some embodiments, when displaying the list of unconnected smart appliances, the terminal may display a colored dot, e.g., red, next to the appliance information of each unconnected smart appliance as a notification, or may display a colored dot, e.g., red, next to the appliance information currently acquired.

FIG. 2F is a diagram showing an interface containing the smart appliance information. Specifically, FIG. 2F shows the terminal after switching from the current interface to the display interface of the list of smart appliances according to the checking instruction triggered by the user.

FIG. 2G is a diagram showing another interface containing the smart appliance information. In the example shown in FIG. 2G the terminal displays the list of unconnected smart appliances in the current interface in a pop-up window, and the list of smart appliances displays appliance information of the unconnected smart appliances that is currently acquired.

Referring again to FIG. 2A, at 203, a network-selecting interface is displayed according to a connecting instruction. The network-selecting interface indicates at least one wireless network to which the terminal has been connected. The connecting instruction is triggered by the user and at least contains the appliance identification.

In some embodiments, after receiving the connecting instruction triggered by the user, the terminal may also display a notification interface for notifying the user to connect the smart appliance to a power supply, as shown in FIG. 2H. In FIG. 2H, the terminal displays a name of the smart appliance selected by the user, and displays a notification message below the name.

After an operation instruction of entering the next step triggered by the user is received, if currently there is only one wireless network, the terminal can directly determine the only wireless network as the wireless network that the user wishes to connect the smart appliance to. If there are at least two wireless networks, the terminal may select the one that the terminal is connected to, and determine the selected wireless network as the wireless network that the user wishes to connect the smart appliance to.

In some embodiments, the terminal may automatically select a wireless network according to a predetermined selection strategy. For example, the terminal may detect signal quality of the wireless networks, and select a wireless network that has best signal quality. Alternatively, the terminal may select a default wireless network. The terminal may also display a network-selecting interface for indicating wireless networks, from which the user can select one to connect the smart appliance. For example, as shown in FIG. 2I, which is a schematic diagram of a network-selecting interface, available networks include Blue Tooth networks “MO-MO” and “LSD,” and Wi-Fi networks “China-LLR”, “Qwe-sdx,” and “Xiaomin,” to which the terminal can be connected.

In some embodiments, as shown in FIG. 2A, displaying a notification (202 in FIG. 2A) is not necessary. Thus, the terminal can display the network-selecting interface (203 in FIG. 2A) directly after receiving the appliance information.

At 204, a network-selecting instruction triggered by the user is received. The network-selecting instruction contains one wireless network selected from the at least one wireless network. The user can select one wireless network from the wireless networks displayed on the network-selecting interface for connecting the smart appliance, and trigger the network-selecting instruction. Correspondingly, the terminal receives the network-selecting instruction triggered by the user.

In some embodiments, the user can enter information about the selected wireless network in an input box on the network-selecting interface, or can select information about the wireless network from options of wireless networks presented on the network-selecting interface. The network-selecting instruction can be generated according to the information.

At 205, network-connecting information of the selected wireless network is sent to the smart appliance, for connecting the smart appliance to the wireless network according to the network-connecting information. In some embodiments, the network-connecting information at least contains a network identification for identifying the wireless network that the smart appliance can be connected to. In some embodiments, the network-connecting information can also contain a network password, to improve security of the network connection.

The terminal sends the network-connecting information of the wireless network selected by the user according to the network-selecting instruction to the smart appliance. Correspondingly, the smart appliance receives the network-connecting information, and connects to the wireless network according to the network-connecting information.

After determining that the smart appliance is connected to a wireless network, the terminal can automatically establish a connection with the smart appliance. After the connection is successfully established, the terminal can display the name and connection state of the smart appliance on the interface of the list of smart appliances.

In some embodiments, the terminal can also display data information collected by the smart appliance on the interface of the list of smart appliances. For example, when the smart appliance is a smart air purifier, the terminal can display the name and the connection state of the smart air purifier on the interface of the list of smart appliances, and display data information of current air quality inside a room acquired by the smart air purifier.

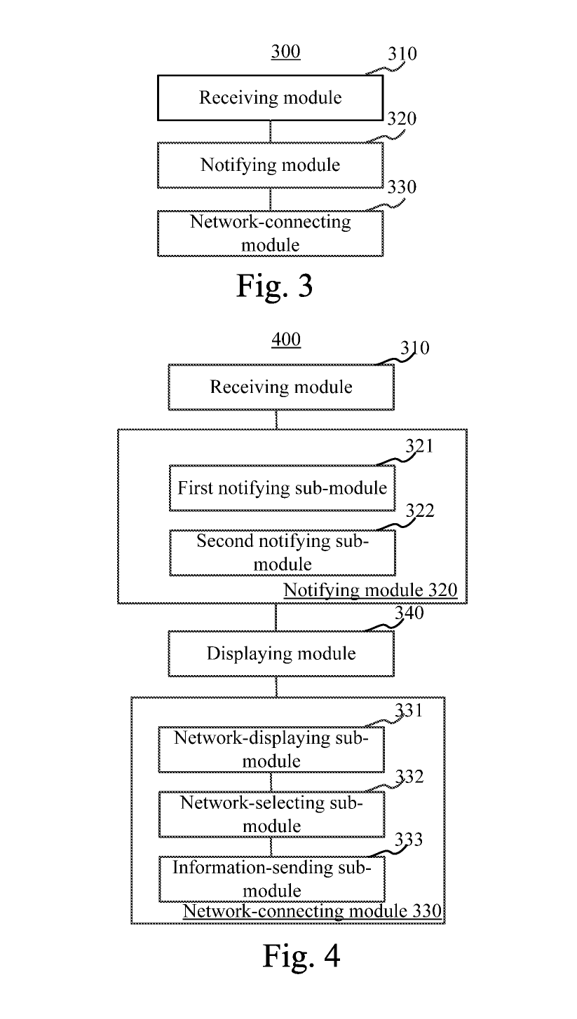

FIG. 3 is a block diagram of a device 300 for connecting an appliance to a network according to an exemplary embodiment. As shown in FIG. 3, the device 300 includes a receiving module 310, a notifying module 320, and a network-connecting module 330. The receiving module 310 is configured to receive appliance information broadcast by a smart appliance. The appliance information at least contains an appliance identification of the smart appliance. The notifying module 320 is configured to display a notification for connecting the smart appliance to a wireless network. The network-connecting module 330 is configured to connect the smart appliance to the wireless network according to a connecting instruction triggered by a user according to the notification when the connecting instruction is received.

FIG. 4 is a block diagram of a device 400 for connecting an appliance to a network according to another exemplary embodiment. As shown in FIG. 4, the device 400 includes the receiving module 310, the prompting module 320, and the network-connecting module 330.

In some embodiments, as shown in FIG. 4, the notifying module 320 includes a first notifying sub-module 321 and a second notifying sub-module 322. The first notifying sub-module 321 is configured to add the appliance information to a list of smart appliances if a current interface of the terminal is a display interface of the list of smart appliances. The second notifying sub-module 322 is configured to display a notification icon in a predetermined item on the current interface of the terminal, whether the current interface is the display interface of the list of smart appliances or another interface. The notification icon indicates that the terminal has received the appliance information.

In some embodiments, the first notifying sub-module 321 is further configured to determine an unconnected smart appliance in the list of smart appliances, and display appliance information of the determined unconnected smart appliance in a flashing manner. In some embodiments, the second notifying sub-module 322 is further configured to display a colored dot, e.g., red, at a predetermined position of the predetermined item, or to acquire and display the number of the smart appliances at the predetermined position of the predetermined item.

In some embodiments, as shown in FIG. 4, the device 400 further includes a displaying module 340 configured to receive a checking instruction triggered by the user according to the predetermined item, and to display the appliance information according to the checking instruction.

In some embodiments, as shown in FIG. 4, the network-connecting module 330 includes a network-displaying sub-module 331, a network-selecting sub-module 332, and an information-sending sub-module 333. The network-displaying sub-module 331 is configured to display a network-selecting interface according to a connecting instruction triggered by the user. The network-selecting interface indicates at least one wireless network to which the terminal is connected. The network-selecting sub-module 332 is configured to receive a network-selecting instruction triggered by the user. The network-selecting instruction contains one wireless network selected from the at least one wireless network displayed by the network-displaying sub-module 331. The information-sending sub-module 333 is configured to send network-connecting information of the wireless network selected by the network-selecting sub-module 332 to the smart appliance, for connecting the smart appliance to the wireless network according to the network-connecting information.

Specific manners of operations of individual modules described above are similar to the methods consistent with embodiments of the present disclosure and described above, and thus will not be repeated.

According to the present disclosure, there is provided a device for connecting an appliance to a network. The device includes a processor and a non-transitory computer-readable storage medium storing instructions that, when executed by the processor, cause the processor to perform a method consistent with embodiments of the present disclosure.

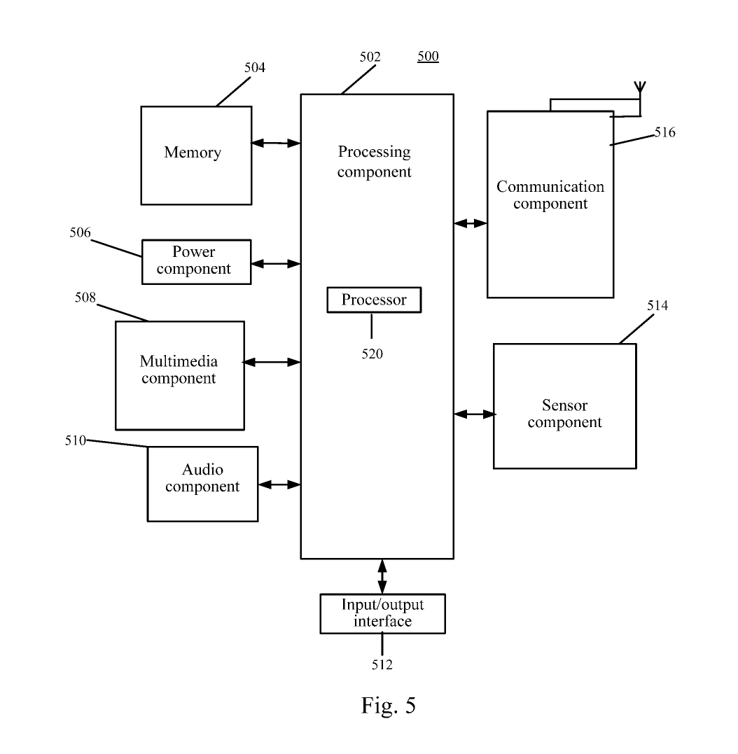

FIG. 5 is a block diagram of a device 500 configured to connect an appliance to a network according to another exemplary embodiment. For example, the device 500 may be a mobile phone, a computer, a digital broadcast terminal, a messaging device, a gaming console, a tablet, a medical device, exercise equipment, a personal digital assistant, or the like.

Referring to FIG. 5, the device 500 includes one or more of the following components a processing component 502, a memory 504, a power component 506, a multimedia component 508, an audio component 510, an input/output (I/O) interface 512, a sensor component 514, and a communication component 516.

The processing component 502 typically controls overall operations of the device 500, such as the operations associated with display, telephone calls, data communications, camera operations, and recording operations. The processing component 502 may include one or more processors 520 to execute instructions to perform all or part of the methods consistent with embodiments of the present disclosure. Moreover, the processing component 502 may include one or more modules which facilitate the interaction between the processing component 502 and other components. For instance, the processing component 502 may include a multimedia module to facilitate the interaction between the multimedia component 508 and the processing component 502.

The memory 504 is configured to store various types of data to support the operation of the device 500. Examples of such data include instructions for any applications or methods operated on the device 500, contact data, phonebook data, messages, pictures, video, etc. The memory 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the device 500. The power component 506 may include a power management system, one or more power sources, and any other components associated with the generation, management, and distribution of power in the device 500.

The multimedia component 508 includes a screen providing an output interface between the device 500 and the user. In some embodiments, the screen may include a liquid crystal display (LCD) and a touch panel. If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the device 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the device 500 is in an operation mode, such as a call mode, a recording mode, and a voice recognition mode. The received audio signal may be further stored in the memory 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 includes one or more sensors to provide status assessments of various aspects of the device 500. For instance, the sensor component 514 may detect an open/closed status of the device 500, relative positioning of components, e.g., the display and the keypad, of the device 500, a change in position of the device 500 or a component of the device 500, a presence or absence of user contact with the device 500, an orientation or an acceleration/deceleration of the device 500, and a change in temperature of the device 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor, or a temperature sensor.

The communication component 516 is configured to facilitate communication, wired or wirelessly, between the device 500 and other devices. The device 500 can access a wireless network based on a communication standard, such as WiFi, 2G, 3G, or 4G or a combination thereof. In one exemplary embodiment, the communication component 516 receives a broadcast signal or broadcast associated information from an external broadcast management system via a broadcast channel. In one exemplary embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above method.

In exemplary embodiments, there is also provided a non-transitory computer-readable storage medium including instructions, such as included in the memory 504, executable by the processor 520 in the device 500, for performing the methods consistent with embodiments of the present disclosure. For example, the non-transitory computer-readable storage medium may be a ROM, a RAM, a CD-ROM, a magnetic tape, a floppy disc, an optical data storage device, or the like.

According to the present disclosure, a terminal can discover a smart appliance that is broadcasting appliance information of the smart appliance, and connect the smart appliance to a wireless network. Therefore, the smart appliance does not need to search for the wireless network and can be connected to the wireless network without entering a network password. As a result, the operation for connecting the smart appliance to the network is simplified and the efficiency of connecting the smart appliance to the network is improved.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for connecting an unconnected smart appliance to a wireless network, comprising:
receiving, by a terminal, appliance information broadcast by the unconnected smart appliance, the appliance information at least containing an appliance identification of the unconnected smart appliance;
displaying, by the terminal, a notification for connecting the unconnected smart appliance to the wireless network;
receiving, by the terminal, a connecting instruction triggered by a user according to the notification; and
connecting the unconnected smart appliance to the wireless network according to the connecting instruction.

2. The method according to claim 1, wherein:
a current interface of the terminal is a display interface of a list of smart appliances, and
displaying the notification includes adding the appliance information of the unconnected smart appliance to the list of smart appliances.

3. The method according to claim 2, wherein adding the appliance information to the list of smart appliances includes displaying the appliance information of the unconnected smart appliance in a flashing manner.

4. The method according to claim 2, further comprising:
receiving a checking instruction triggered by the user according to a predetermined item; and
displaying the appliance information of the unconnected smart appliance according to the checking instruction.

5. The method according to claim 1, wherein displaying the notification includes displaying a notification icon in a predetermined item on a current interface of the terminal, the notification icon indicating that the terminal has received the appliance information of the unconnected smart appliance.

6. The method according to claim 5, wherein displaying the notification icon includes:
displaying a pattern at a predetermined position of the predetermined item; or
acquiring a number of unconnected smart appliances acquired by the terminal and displaying the number at the predetermined position.

7. The method according to claim 1, wherein connecting the unconnected smart appliance to the wireless network includes:
displaying a network-selecting interface according to the connecting instruction, the network-selecting interface indicating at least one wireless network to which the terminal is connected;
receiving a network-selecting instruction triggered by the user, the network-selecting instruction containing one wireless network selected from the at least one wireless network; and
sending network-connecting information of the selected wireless network to the unconnected smart appliance.

8. A terminal for connecting an unconnected smart appliance to a wireless network, the terminal comprising:
a processor; and
a non-transitory computer-readable storage medium storing instructions that, when executed by the processor, cause the processor to:
receive appliance information broadcast by the unconnected smart appliance, the appliance information at least containing an appliance identification of the unconnected smart appliance;
display a notification for connecting the unconnected smart appliance to the wireless network;
receive a connecting instruction triggered by a user according to the notification; and
connect the unconnected smart appliance to the wireless network according to the connecting instruction.

9. The terminal according to claim 8, wherein:
a current interface of the terminal is a display interface of a list of smart appliances, and
the instructions further cause the processor to:
add the appliance information of the unconnected smart appliance to the list of smart appliances.

10. The terminal according to claim 9, wherein the instructions further cause the processor to:
display the appliance information of the unconnected smart appliance in a flashing manner.

11. The terminal according to claim 9, wherein the instructions further cause the processor to:
receive a checking instruction triggered by the user according to a predetermined item; and
display the appliance information according to the checking instruction.

12. The terminal according to claim 8, wherein the instructions further cause the processor to:
display a notification icon in a predetermined item on a current interface of the terminal, the notification icon indicating that the terminal has received the appliance information of the unconnected smart appliance.

13. The terminal according to claim 12, wherein the instructions further cause the processor to:
display a pattern at a predetermined position of the predetermined item; or
acquire a number of unconnected smart appliances acquired by the terminal and display the number at the predetermined position.

14. The terminal according to claim 8, wherein the instructions further cause the processor to:
display a network-selecting interface indicating at least one wireless network to which the terminal is connected;
receive a network-selecting instruction triggered by the user, the network-selecting instruction containing one wireless network selected from the at least one wireless network; and
send network-connecting information of the selected wireless network to the unconnected smart appliance.

15. A non-transitory computer-readable storage medium storing instructions that, when executed by a processor of a terminal, cause the terminal to:
receive appliance information broadcast by an unconnected smart appliance, the appliance information at least containing an appliance identification of the unconnected smart appliance;
display a notification for connecting the unconnected smart appliance to a wireless network;
receive a connecting instruction triggered by a user according to the notification; and
connect the unconnected smart appliance to the wireless network according to the connecting instruction.
